(19) United States
(12) Patent Application Publication
(10) Pub. No.: US 2021/0396016 A1
(43) Pub. Date: Dec. 23, 2021

(54) WATERSLIDE DOG LADDER

(71) Applicants: Michael A. Turner, SR., Savannah, GA (US); Michael A. Turner, JR., Savannah, GA (US)

(72) Inventors: Michael A. Turner, SR., Savannah, GA (US); Michael A. Turner, JR., Savannah, GA (US)

(21) Appl. No.: 16/904,109

(22) Filed: Jun. 17, 2020

(51) Int. Cl. E04F 11/00; A01K 15/02

(52) U.S. Cl. CPC E04F 11/002; E04F 2011/005; A01K 15/025

(57) ABSTRACT

A system for providing a pet ladder, and more specifically, to a system for providing a dog ladder for use in of a body of water that may fold out of the water when not in use. is disclosed. The waterside dog ladder is typically attached to a pier, dock, seawall or similar waterside structure that abuts a body of water. The dog ladder has a platform and a plurality of ladder sections. The length of the multiple ladder sections when connected end to end permits the dog ladder to extend from the platform to the water bottom. The dog ladder folds into a retracted position to completely remove the multiple sections from the water when not in use. The ladder is a positive-stop ladder so that each section folds until it hits a stop and provides a firm and solid footing for the dog at a predefined angle that the dog can manage. The rigid and solid feel makes the dog confident and relaxed when exiting the water.

### TECHNICAL FIELD

This application relates in general to a system for providing a pet ladder, and more specifically, to a system for providing a dog ladder for use in of a body of water that may fold out of the water when not in use.

### BACKGROUND

When our canine companions are playing, exercising or competing in water, they can have difficulty exiting deep water. The Waterside Dog Ladder makes it safer and easier for dogs to emerge from deep water onto a dock, pier, seawall or other waterside structure. If a dog cannot get out of the water, it has several problems including: cutting its paws on oyster shells, cutting its paws on jagged rocks and debris, tiring or drowning by not being able to scale a vertical seawall, or just simply getting very muddy.

Dogs love the water and millions of owners play with, train, and exercise their dogs in and around bodies of water. Other owners' dogs compete in aquatic, dock diving, and water retrieval events. Therefore, a need exists for a foldable dog swim ladder that can be easily folded out from the water.

### SUMMARY

In accordance with the present invention, the above and other problems are solved by a dog ladder for use in of a body of water that may fold out of the water when not in use according to the principles and example embodiment disclosed herein.

In one embodiment, the present invention is a system for a waterside pet ladder that allows dogs to easily and safely move in and out of the water. The Waterside Dog Ladder is typically attached to a pier, dock, seawall or similar structure that abuts a body of water. The dog ladder is comprised of a platform and a several ladder sections. The length of the multiple ladder sections when connected end to end permits the dog ladder to extend from the platform to the water bottom. The dog ladder folds into a retracted position to completely remove the multiple sections from the water when not in use. The ladder is a “positive stop” ladder that gives a dog a solid sense of footing. Buoyancy ramps do not provide this solid feeling and sometimes scaring the dog when a buoyancy ramps sinks.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for a system that provides a deployed dog ladder into a body of water according to the present invention.

FIG. 2a-d illustrates an example embodiment for a base platform that provides a deployed dog ladder into a body of water according to the present invention.

FIG. 3a-d illustrates an example embodiment for a first ladder section that provides a deployed dog ladder into a body of water according to the present invention.

FIG. 4a-d illustrates an example embodiment for a second ladder section that provides a deployed dog ladder into a body of water according to the present invention.

FIG. 5a-d illustrates an example embodiment for a third ladder section that provides a deployed dog ladder into a body of water according to the present invention.

FIG. 6 illustrates an example embodiment for a system that provides a retracted dog ladder out of a body of water according to the present invention.

### DETAILED DESCRIPTION

This application relates in general a system for providing a dog ladder, and more specifically, to a system for providing a dog ladder that may fold out of a body of water when not in use according to the present invention.

An embodiment of the present invention will be described in detail with reference to the drawings, wherein like reference numerals represent like parts and assemblies throughout the views. Reference to this embodiment does not limit the scope of the invention, which is limited only by the scope of the claims attached hereto. Additionally, any example set forth in this specification is not intended to be limiting and merely sets forth one of the many possible embodiments for the claimed invention.

It further will be understood that the terms “comprises,” “comprising,” “includes,” and “including” specify the presence of stated features, steps or components, but do not preclude the presence or addition of one or more other features, steps or components.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill.

The terms “owner” and “user” refer to an entity, e.g. a human, owning a dog that uses a water ladder associated with the invention. The term user herein may refer to one or more users.

The term “invention” or “present invention” refers to the invention being applied for via the patent application with the title “Waterside Dog Ladder.” Invention may be used interchangeably with “dog ladder” or “waterside dog ladder.”

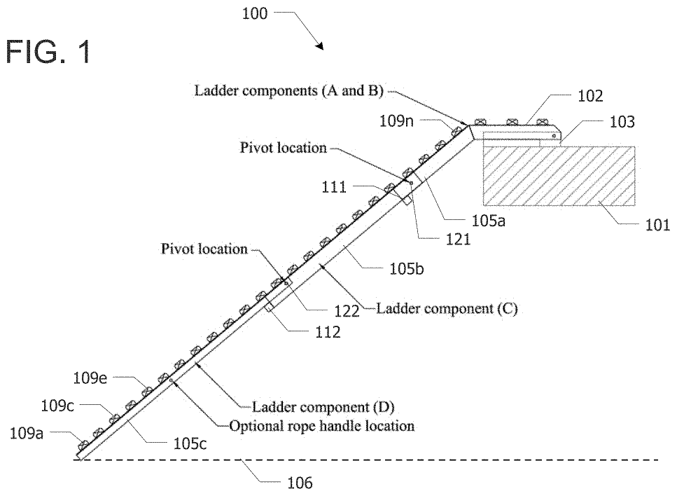

In general, the present disclosure relates a system for providing a dog ladder into a body of water that may fold out of the water when not in use. To better understand the present invention, FIG. 1 illustrates an example embodiment for a system that provides a deployed dog ladder into a body of water according to the present invention. A waterside dog ladder 100 is typically attached to a pier 101, dock, seawall or similar waterside structure that abuts a body of water. The dog ladder 100 consists of a platform 102 and two or more ladder sections 105a-c. The example embodiment in FIG. 1 shows three ladder section connected end to end that permits the dog ladder 100 to extend from the platform 102 to the water bottom 106.

The ladder is a positive-stop ladder so that each section folds until it hits a stop and provides a firm and solid footing for the dog at a predefined angle that the dog can manage. The rigid and solid feel makes the dog confident and relaxed when exiting the water. Each of the ladder sections 105a-c are covered on the upper side by a set of planking 109a-n to create a walkable path for a dog from the water to the platform 102. This set of planking 109a-n may be of any dimension and spacing, but typically a small space is left between each pair of planks to provide a ridge in the ladder for the dog's paws to engage and to minimize the weight of the ladder sections 105a-c. The combined length of the ladder sections 105a-c is typically long enough to reach the water bottom 106 while providing a slope of 45-soa that permits the dog to easily exit the water. The needed length is easily calculated using the height of the pier 101 from the water bottom and the desired slope for the dog ladder 100.

Sides of a second section 105b and a third section 105c extend beyond their respective ends to create connection components that couple each section to its adjacent section. A first section 105a is permanently coupled to the platform 102 in a fixed position and extends to a point expected to remain above a high tide waterline. This length of the first section 105a permits all of the dog ladder 100 to be removed from the water when placed into a retracted position.

A first edge abutment 111 is connected to the first section 105a to form an abutment surface between the second section 105b and the first section 105a when the dog ladder is deployed. The second section 105b is coupled to the first section 105a by a first pair connecting bolts 121 between one pair of connection components of the second section 105b on its upper end and a side of the first section 105a. The first pair of connection bolts 121 create a pivot point about which the second section 105b may rotate to lift the lower sections of the dog ladder 100 out of the water.

The second section 105b is also coupled to the third section 105c by a second pair of connecting bolts 122 between a second pair of connection components of the second section 105b on its lower end and a pair of connection components on the top end of a third section 105c. The second pair of connection bolts 122 create a pivot point about which the third section 105c may rotate to move the third section 105c into a safe retracted position when the dog ladder 100 is out of the water. The second section 105b and the third section 105c use a second edge abutment 112 between the sections when in the deployed position to orient the two sections in a parallel orientation.

The dog ladder 100 is typically made of aluminum and wood that has been pressure treated to make it resistant to the effects water. Other materials such as metal and synthetic decking materials may also be used in the construction of the dog ladder 100. The dog ladder 100 may be deployed at the beginning of a day and placed into a retracted position when not in use. The dog ladder 100 typically is kept in its retracted position to avoid keeping parts of the ladder in the water where it may become weathered and damaged.

All of the fasteners and bolts are typically made of stainless steel. All wood components are made of pressure treated wood. The main structural components are made from aluminum to provide support strength while remaining light weight enough to be easily moved as desired.

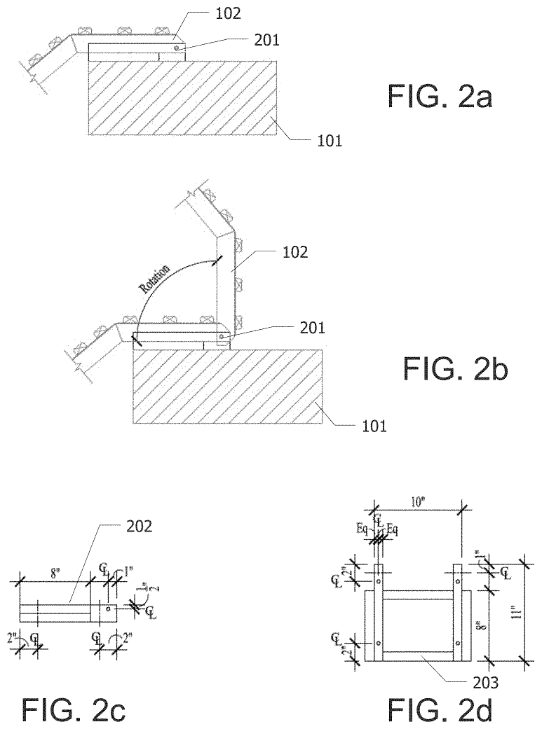

FIG. 2a-d illustrates an example embodiment for a base platform that provides a deployed dog ladder into a body of water according to the present invention. The base platform 102 is shown in its deployed position in FIG. 2a. In contrast, FIG. 2b shows the base platform 102 having been raised into a retracted position in which the platform 102 rotates about a base pivot point 201.

FIG. 2c shows the dimensions of the base platform component itself 202. The components and dimensions of a supporting structure 202 for the base platform 102 is shown in FIG. 2d. The supporting structure 202 is coupled to the pier 101 or other permanent waterside structure.

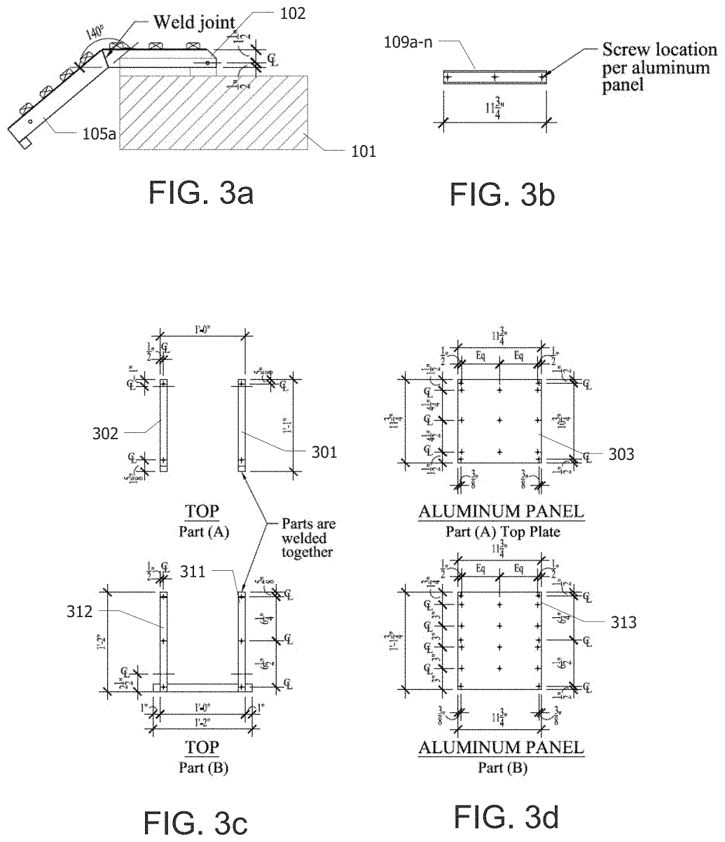

FIG. 3a-d illustrates an example embodiment for a first ladder section that provides a deployed dog ladder into a body of water according to the present invention. FIG. 3a shows the first ladder section 105a is welded to the base platform 102 forming a 140a angle that directs the first ladder section 105a down towards the water. The wooden ladder treads 109a-n are shown in FIG. 3b.

FIG. 3c shows the top components 301-302 and the aluminum panel top plate 303 of the platform base 102. The platform base 102 is also identified as part A in the Figures. FIG. 3d shows the top components 311-312 and the aluminum panel top plate 333 of the first ladder section 105a. The first ladder section 105a is also identified as part B in the Figures.

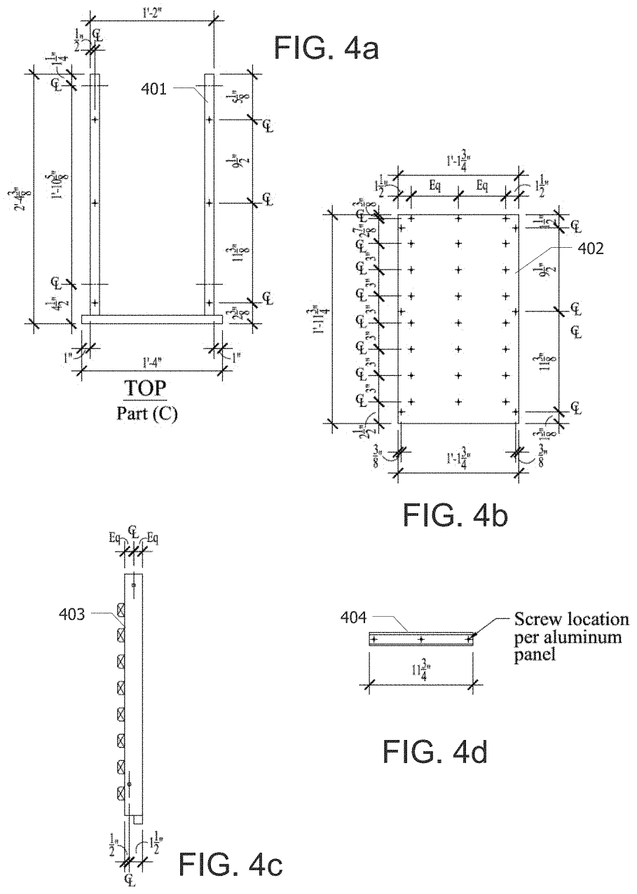

FIG. 4a-d illustrates an example embodiment for a second ladder section that provides a deployed dog ladder into a body of water according to the present invention. FIG. 4a shows the dimensions of top supporting components 401 for the second ladder section 105b. FIG. 4b shows the dimensions of an aluminum panel top plate for the second ladder section 105b. FIG. 4c shows the assembled second ladder section 105b. The wooden ladder treads 109a-n are shown in FIG. 4d. The second ladder section 105b is also identified as Part C in the Figures.

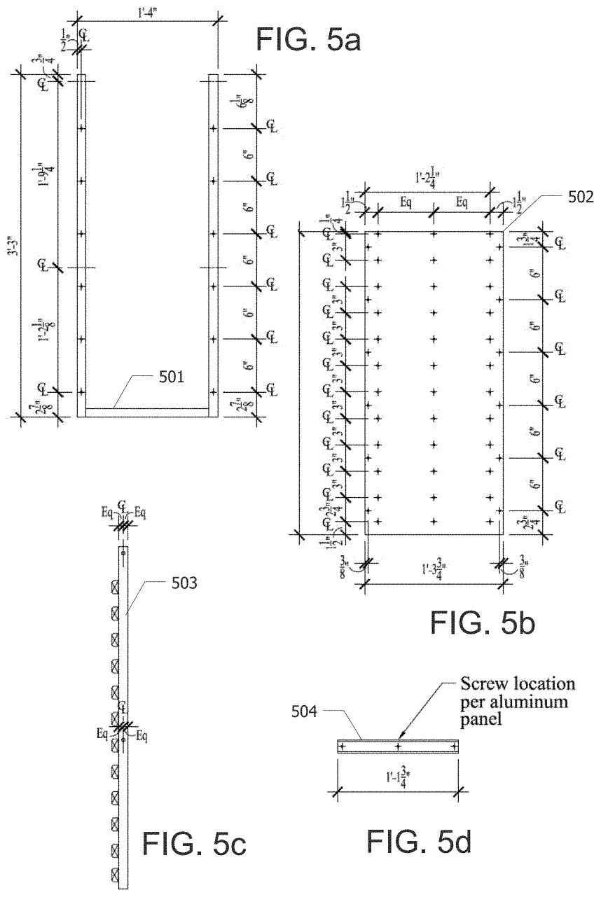

FIG. 5a-c illustrates an example embodiment for a third ladder section that provides a deployed dog ladder into a body of water according to the present invention. Fig. Sa shows the dimensions of top supporting components 501 for the third ladder section 105c. Fig. Sb shows the dimensions of an aluminum panel top plate for the third ladder section 105c. Fig. Sc shows the assembled third ladder section 105c. The wooden ladder treads 109a-n are shown in FIG. 5d. The third ladder section 105c is also identified as Part D in the Figures.

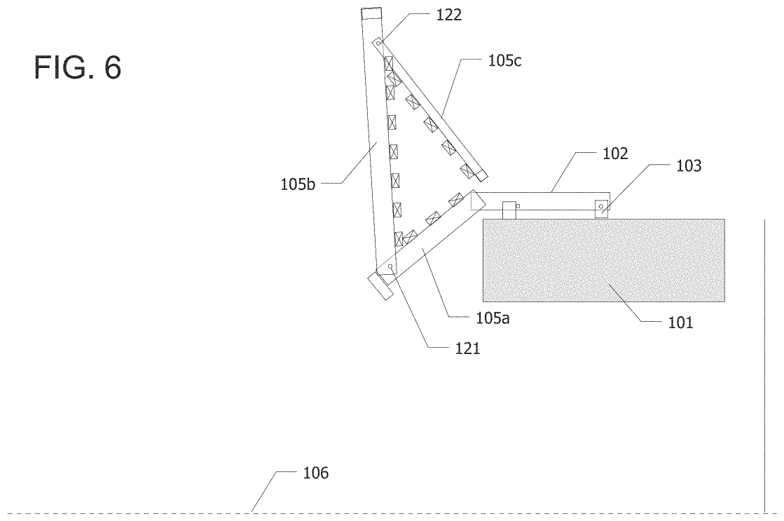

FIG. 6 illustrates an example embodiment for a system that provides a retracted dog ladder out of a body of water according to the present invention. In the retracted position, the second section 105b has pivoted about the first pair of connection bolts 121 until its planking engages the planking of the first section 105. Similarly, the third section 105c has pivoted about the second pair of connection bolts 122 until its planking engages the planking of the second section 105b. A tiedown mechanism 201 may secure one end of the third section 105c to the platform 101 or the first section 105a to prevent the dog ladder 100 from being unintentionally blown back into the water by foul weather or similar unintended forces.

As noted above, individual lengths for each of the ladder sections 105a-c may differ from each other. Typically, the three sections 105a-c will be similar in length as the length of each section affects how far each section extends when the dog ladder 100 is folded into the retracted position.

While the above embodiments describes the use of the ladder 100 by dogs, this terminology is used for example purposes only. Other animals may use the system should the pets accompany their owners to the water. Additionally humans, especially children, may find the dog ladder 100 useful to enter and exit the body of water. The present invention should not be limited by any of these examples and should be defined by the language explicitly recited within the attached claims.

Even though a particular combinations of features is recited in the present application, this combination is not intended to limit the disclosure of the invention. In fact, many of these features may be combined in ways not specifically recited in this application. In other words, any of the features mentioned in this application may be included in this new invention in any combination or combinations to allow the functionality required for the desired operations.

What is claimed is:

1. A system for providing a positive-stop pet ladder, the system comprising:
a base platform coupled to a waterside permanent structure, the base platform pivots upward about a first pivot point adjacent to a back edge of the base platform;
a first ladder section having a first upper end permanently coupled to a front edge of the base platform and having a first lower end extending downward towards a body of water, the first lower end of the first ladder section includes a first stop face; and
one or more additional ladder sections having upper end coupled to the lower end of the first ladder about a second pivot point;
wherein the one or more additional ladder sections pivot about the second pivot point until the upper end of the additional ladder sections come into direct contact with the first stop face.

2. The system according to claim 1, wherein the one or more additional ladder sections comprise:
a second ladder section having a second upper end coupled via the second pivot point to the first lower end of the first ladder section and having a second lower end extending downward into the body of water, the second lower end of the second ladder section includes a second stop face; and
a third ladder section having a third upper end coupled via a third pivot point to the second lower end of the second ladder section and having a second lower end extending downward into the body of water;
wherein the second ladder section pivot about the second pivot point until the upper end of the second ladder sections come into direct contact with the first stop face; and the third ladder section pivot about the third pivot point until the upper end of the third ladder sections come into direct contact with the second stop face.

3. The system according to claim 2, wherein the base platform pivots about the first pivot point, the second ladder section pivots about the second pivot point, and the third ladder section pivots about the third pivot point to orient the ladder into a retracted position completely out of the body of water.

4. The system according to claim 2, wherein the first ladder section, the second ladder section, and the third ladder section all comprise a plurality of ladder treads coupled crosswise along each ladder section.

5. The system according to claim 2, wherein the base platform comprises a plurality of ladder treads coupled crosswise along the base platform.

6. The system according to claim 4, wherein the plurality of ladder treads are made of pressure treated wood.

7. The system according to claim 2, wherein the base platform, the first ladder section, the second ladder section, and the third ladder section all are made from aluminum.

8. The system according to claim 7, wherein the base platform, the first ladder section, the second ladder section, and the third ladder section all are constructed and coupled about the pivot points using fasteners and bolts made from stainless steel.

9. A system for providing a positive-stop pet ladder, the system comprising:
a base platform coupled to a waterside permanent structure, the base platform pivots upward about a first pivot point adjacent to a back edge of the base platform;
a first ladder section having a first upper end permanently coupled to a front edge of the base platform and having a first lower end extending downward towards a body of water, the first lower end of the first ladder section includes a first stop face; and
a second ladder section having a second upper end coupled via the second pivot point to the first lower end of the first ladder section and having a second lower end extending downward into the body of water, the second lower end of the second ladder section includes a second stop face; and
a third ladder section having a third upper end coupled via a third pivot point to the second lower end of the second ladder section and having a second lower end extending downward into the body of water;
wherein the one or more additional ladder sections pivot about the second pivot point until the upper end of the additional ladder sections come into direct contact with the first stop face;
wherein the second ladder section pivot about the second pivot point until the upper end of the second ladder sections come into direct contact with the first stop face;
wherein the third ladder section pivot about the third pivot point until the upper end of the third ladder sections come into direct contact with the second stop face;
wherein the base platform, the first ladder section, the second ladder section, and the third ladder section all comprise a plurality of ladder treads made of pressure treated wood coupled crosswise;
wherein the base platform, the first ladder section, the second ladder section, and the third ladder section all are made from aluminum; and
wherein the base platform, the first ladder section, the second ladder section, and the third ladder section all are constructed and coupled about the pivot points using fasteners and bolts made from stainless steel.

10. The system according to claim 9, wherein the base platform, the first ladder section, the second ladder section, and the third ladder section all are constructed and coupled about the pivot points using fasteners and bolts made from stainless steel.
